(19) United States
(12) Patent Application Publication
(10) Pub. No.: US 2026/0168682 A1
(43) Pub. Date: Jun. 18, 2026

(54) DEHUMIDIFYING SYSTEM

(71) Applicant: MUNTERS EUROPE AKTIEBOLAG, Kista (SE)

(72) Inventor: Kazunori Yamanaka, Tokyo (JP)

(21) Appl. No.: 19/123,637

(22) PCT Filed: Oct. 12, 2023
(86) PCT No.: PCT/JP2023/037074

§ 371 Date: Apr. 23, 2025

(30) Foreign Application Priority Data
Oct. 25, 2022 (JP) 2022-170288
Oct. 25, 2022 (SE) 2251237-0

(51) Int. Cl. F24F 3/14; B01D 53/26

(52) U.S. Cl. CPC F24F 3/1423; B01D 53/261; B01D 2259/40088; F24F 2203/1032; F24F 2203/1068

(57) ABSTRACT

To reduce energy consumption in a dehumidifying system that employs sorbent rotors. Process air (OA) is dehumidified in two steps by a sorbent rotor (20) for a first processing step and a sorbent rotor (50) for a second processing step. A sorbent rotor equipped with a processing region (1a) where the process air is dehumidified, a regenerating region (1b), a first purging region (1c), and a second purging region (1d) is employed as the sorbent rotor (50) for the second processing step. A circulating purging channel (40) is provided to preheat and precool a sorbent of the sorbent rotor (50) for the second processing step. A regenerating air channel (30) that feeds at least a portion of processed air which has been dehumidified by the sorbent rotor (20) for the first processing step to the regenerating region (1b) of the sorbent rotor (50) for the second processing step as regenerating air is also provided.

### TECHNICAL FIELD

The present invention is related to a dehumidifying system, and more particularly to a dehumidifying system that employs a desiccant dehumidifying device.

### BACKGROUND ART

Conventionally, dehumidifying systems that employ a sorbent rotor constituted by a sorbent held on a rotor to adsorb and remove moisture from air which is a target of a dehumidifying process (process air) are known, as disclosed in Patent Document 1, for example. Further, Patent Document 1 also discloses that a rotational passage region of the sorbent rotor is sectioned into three regions, which are a processing region where dehumidification is performed, a regenerating region where adsorbed moisture is removed from the sorbent, and a purging region where the sorbent is cooled. An air feeding channel that feeds process air to the processing region is branched to provide a purge air feeding channel that feeds a portion of the process air to the purging region, to precool the sorbent at the purging region prior to the sorbent reaching the processing region by rotational movement.

In addition, Patent Document 2 also discloses a dehumidifying system that employs a sorbent rotor similar to that described above. Further, Patent Document 2 also discloses that a rotational passage region of the sorbent rotor is sectioned into four regions, which are a processing region where dehumidification is performed, a regenerating region where adsorbed moisture is removed from the sorbent, a first purging region provided between the regenerating region and the processing region upstream from the regenerating region in the rotational direction of the sorbent rotor, and a second purging region provided between the regenerating region and the processing region downstream from the regenerating region in the rotational direction of the sorbent rotor. In addition, a circulating purging channel that circulates air such that the air alternately passes through the first purging region and the second purging region is also provided.

In the case that sorbent rotors such as those described above are employed, applying two sorbent rotors, and causing air which has passed through the processing region of a first sorbent rotor (for a first processing step) and is dehumidified to pass through the processing region of a second sorbent rotor (for a second processing step), to obtain low dew point air which has been dehumidified to a higher degree has also been proposed, as disclosed in Patent Document 3 (refer to FIG. 12), for example.

### CITATION LIST

### Patent Literature

### [PLT 1]

Japanese Unexamined Patent Publication No. 2010-148997

### [PLT 2]

Japanese Patent No. 6839235

### [PLT 3]

Japanese Unexamined Patent Publication No. 2005-021840

### SUMMARY OF INVENTION

### Technical Problem

Conventional dehumidifying systems that employ two sorbent rotors as described above are advantageous in that air which is dehumidified to a higher degree can be obtained. However, there is room for improvement in decreasing energy consumption of the system as a whole. Therefore, the objective of the present invention is to provide a dehumidifying system having a high energy saving effect which is capable of obtaining air which is dehumidified to a high degree and capable of suppressing energy consumption.

### Solution to Problem

A first dehumidifying system according to the present invention is a dehumidifying system that:
feeds process air to a sorbent rotor to cause moisture within the process air to be adsorbed onto a sorbent of the sorbent rotor to dehumidify the process air; and
causes regenerating air to flow onto the sorbent of the sorbent rotor which has adsorbed moisture to regenerate the sorbent; is provided with:
a sorbent rotor for a first processing step that dehumidifies the process air; and
a sorbent rotor for a second processing step that receives processed air which has been dehumidified by the sorbent rotor for the first processing step and dehumidifies the processed air as the process air; characterized by:
the sorbent rotor for the second processing step being a sorbent rotor having a rotational passage region that is sectioned into four regions, which are a processing region where the process air is dehumidified, a regenerating region where is regenerated the sorbent is regenerated, a first purging region provided between the regenerating region and the processing region upstream from the regenerating region in the rotational direction of the sorbent rotor, and a second purging region provided between the regenerating region and the processing region downstream from the regenerating region in the rotational direction of the sorbent rotor;
a circulating purging channel that circulates air such that the air alternately passes through the first purging region and the second purging region being provided; and
a regenerating air channel that feeds at least a portion of the processed air which is processed by the sorbent rotor for the first processing step to the regenerating region of the sorbent rotor for the second processing step as regenerating air being provided.

In the first dehumidifying system according to the present invention having the configuration described above, it is desirable for:
a second regenerating air channel that feeds at least a portion of the processed air which has passed through the regenerating region of the sorbent rotor for the second processing step as regenerating air to the regenerating region of the sorbent rotor for the first processing step to be further provided.

In addition, a second dehumidifying system of the present invention is a dehumidifying system that:
feeds process air to a sorbent rotor to cause moisture within the process air to be adsorbed onto a sorbent of the sorbent rotor to dehumidify the process air; and
causes regenerating air to flow onto the sorbent of the sorbent rotor which has adsorbed moisture to regenerate the sorbent; is provided with:
a sorbent rotor for a first processing step that dehumidifies the process air; and
a sorbent rotor for a second processing step that receives processed air which has been dehumidified by the sorbent rotor for the first processing step and dehumidifies the processed air as the process air; characterized by:
the sorbent rotor for the second processing step being a sorbent rotor having a rotational passage region that is sectioned into four regions, which are a processing region where the process air is dehumidified, a regenerating region where the sorbent is regenerated, a first purging region provided between the regenerating region and the processing region upstream from the regenerating region in the rotational direction of the sorbent rotor, and a second purging region provided between the regenerating region and the processing region downstream from the regenerating region in the rotational direction of the sorbent rotor;
a circulating purging channel that circulates air such that the air alternately passes through the first purging region and the second purging region being provided;
the sorbent rotor for the first processing step being a sorbent rotor having a rotational passage region that is sectioned into a processing region where the process air is dehumidified, a regenerating region where the sorbent is regenerated, and a purging region provided between the regenerating region and the processing region where the sorbent is precooled prior to entering the processing region; and
a regenerating air channel that feeds at least a portion of air at a purge outlet which has passed through the purging region of the sorbent rotor for the first processing step to the regenerating region of the sorbent rotor for the second processing step as regenerating air being provided.

In the second dehumidifying system according to the present invention having the configuration described above, it is desirable for:
a second regenerating air channel that feeds at least a portion of the air at the purge outlet which has passed through the regenerating region of the sorbent rotor for the second processing step as regenerating air to the regenerating region of the sorbent rotor for the first processing step to be further provided.

### Advantageous Effects of Invention

Both of the dehumidifying systems according to the present invention dehumidify the process air with the sorbent rotor for the first processing step and the sorbent rotor for the second processing step, and therefor are capable of obtaining air which has been dehumidified to a high degree. As described above, a sorbent rotor having a rotational passage region that is sectioned into four regions, which are a processing region, a regenerating region, a first purging region, and a second purging region is employed as the sorbent rotor for the second processing step. In addition, the circulating purging channel that circulates air such that the air alternately passes through the first purging region and the second purging regions is provided. Therefore, the dehumidifying systems are capable of reducing energy consumption of the systems as a whole.

The dehumidifying systems according to the present invention are also capable of reducing energy consumption due to the points below. That is, the first dehumidifying system of the present invention is provided with the regenerating air channel that feeds at least a portion of the processed air which is processed by the sorbent rotor for the first processing step to the regenerating region of the sorbent rotor for the second processing step as regenerating air. Thereby, it becomes possible to effectively utilize exhaust heat of the processed air to regenerate the sorbent rotor for the second processing step. Meanwhile, the second dehumidifying system of the present invention is provided with the regenerating air channel that feeds at least a portion of air at a purge outlet which has passed through the purging region of the sorbent rotor for the first processing step to the regenerating region of the sorbent rotor for the second processing step as regenerating air. Thereby, it becomes possible to effectively utilize exhaust heat of the air at the purge outlet to regenerate the sorbent rotor for the second processing step.

In both of the first dehumidifying system and the second dehumidifying system according to the present invention, a regenerating heater for the sorbent rotor for the second processing step can be of low capacity and miniaturized, to further reduce energy consumption by the systems as a whole. The above effect will become more significant in the case that the first dehumidifying system and the second dehumidifying system of the present invention are provided with the aforementioned second regenerating air channels, since a regenerating heater for the sorbent rotor for the first processing step can also be of low capacity and miniaturized.

### BRIEF DESCRIPTION OF DRAWINGS

FIG. 1 A diagram that schematically illustrates a dehumidifying system according to a first embodiment of the present invention

FIG. 2 A diagram that schematically illustrates the main components of the dehumidifying system of FIG. 1

FIG. 3 A diagram that schematically illustrates other main components of the dehumidifying system of FIG. 1

FIG. 4 A diagram that schematically illustrates a dehumidifying system according to a second embodiment of the present invention

FIG. 5 A diagram that schematically illustrates the main components of the dehumidifying system of FIG. 4

FIG. 6 A diagram that schematically illustrates an example of a conventional dehumidifying system.

### DESCRIPTION OF EMBODIMENTS

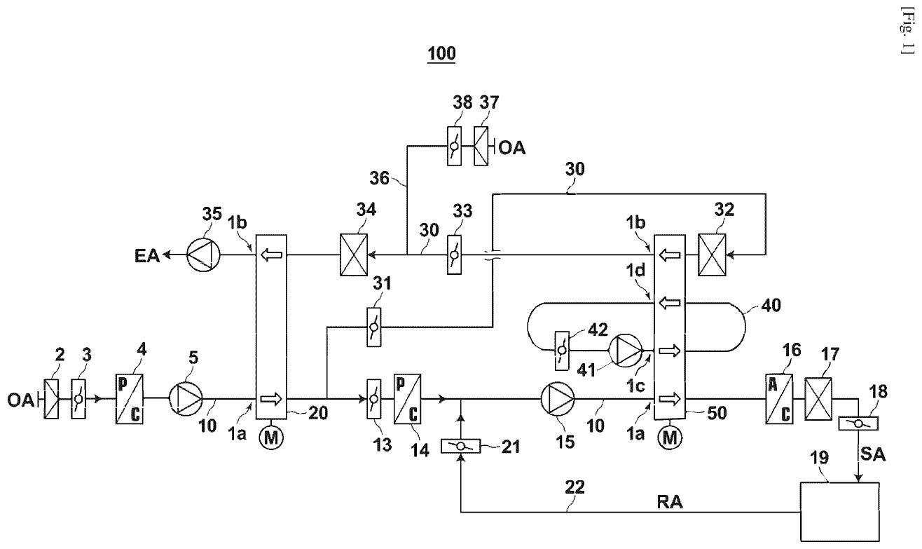

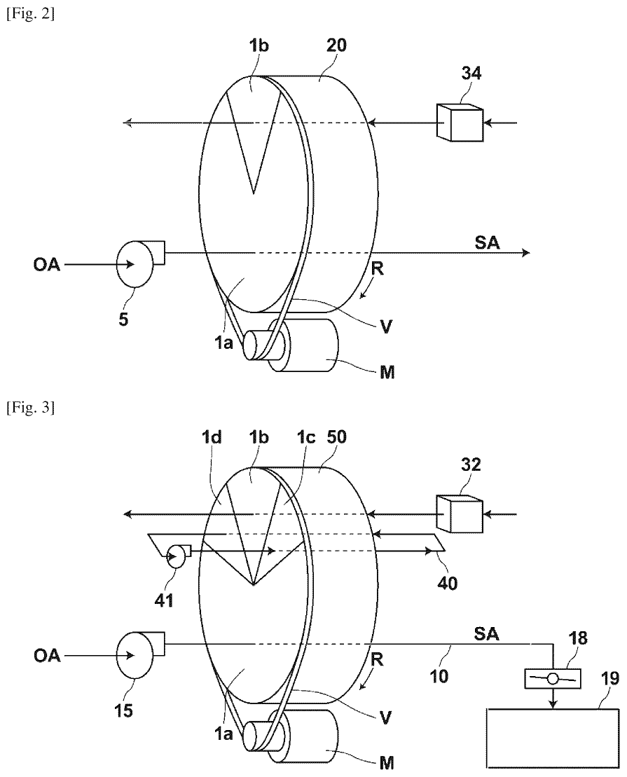

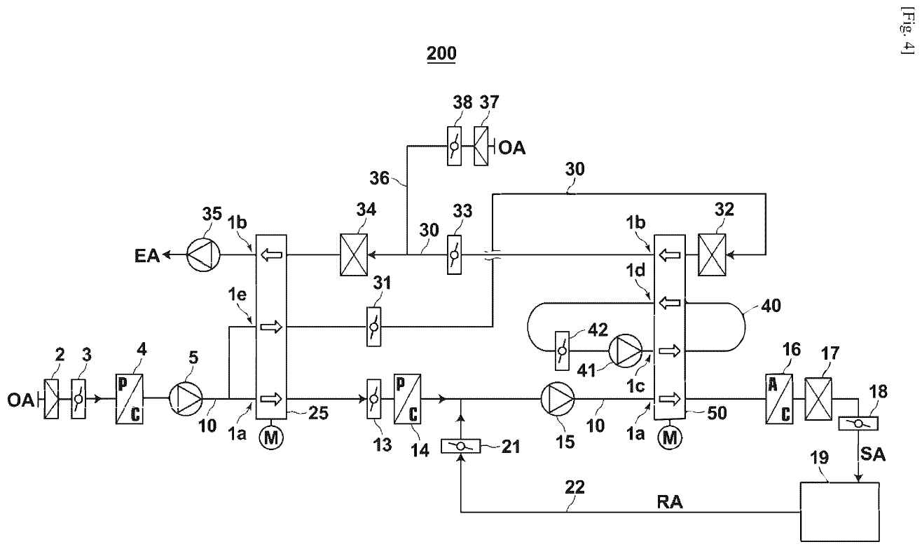

Hereinafter, embodiments of the present invention will be described with reference to the attached drawings. First, a dehumidifying system 100 according to a first embodiment of the present invention will be described with reference to FIG. 1 through FIG. 3. FIG. 1 illustrates the entire configuration of the dehumidifying system 100. FIG. 2 illustrates a sorbent rotor 20 for a first processing step and peripheral components thereof, and FIG. 3 illustrates a sorbent rotor 50 for a second processing step and peripheral components thereof. The sorbent rotor 20 and the sorbent rotor 50 are components that constitute the dehumidifying system 100. The sorbent rotors 20 and 50 for the first processing step and the second processing step are both those that constitute a so called desiccant dehumidifying device and dehumidify process air (air which is a target of a dehumidifying process) which is supplied thereto.

The sorbent rotor 20 for the first processing step is that which is generally referred to as a dehumidifying rotor or a desiccant rotor. The sorbent rotor 20 is constituted by a honeycomb structure which is formed into a cylindrical shape and having a sorbent housed therein, for example, as clearly illustrated in FIG. 2. An optimal sorbent is selected from among chemical substances such as silica gel, zeolite composite materials, and lithium chloride, according to environmental temperature and humidity as well as environmental air quality, and utilized. The sorbent rotor 20 is rotated in the circumferential direction thereof, that is, the direction denoted by arrow R in FIG. 2, by a drive device constituted by a motor M, a driving force transmission belt V, etc. A rotational passage region (a region that each portion of the sorbent rotor 20 passes through as the sorbent rotor 20 rotates) is divided into two regions which are hermetically isolated from each other by a casing (not shown) that rotatably houses the sorbent rotor 20. The two regions are a processing (adsorbing) region 1a where the process air is dehumidified, and a regenerating region 1b. Each sorbent portion of the sorbent rotor 20 passes through the two regions in the order of 1a, 1b, 1a, . . . as the sorbent rotor 20 rotates.

An air processing channel 10 is in communication with the processing region 1a while maintaining a hermetically sealed state. The air processing channel 10 is a channel that supplies process air, that is, air which is a target of a dehumidifying process, to the sorbent rotor 20 and receives processed air SA which has passed through the sorbent rotor 20. In the present example, the process air is external air OA. A prefilter 2 for removing dust and the like from air, a damper 3, a precooler 4, and a processing fan 5 are provided in this order in the air processing channel 10 at a side upstream from the sorbent rotor 20. A damper 13, a precooler 14, and a processing fan 15, each of which are of the same configuration as the damper 3, the precooler 4, and the processing fan 5, are provided in this order in the air processing channel 10 at a side downstream from the sorbent rotor 20.

The air processing channel 10 is connected to the sorbent rotor 50 for the second processing step at a side downstream from the processing fan 15. The sorbent rotor 50 for the second processing step is constituted by a honeycomb structure which is formed into a cylindrical shape and having a sorbent housed therein in a manner similar to the sorbent rotor 20 for the first processing step, for example, as illustrated in FIG. 3. The sorbent rotor 50 is also rotated in the circumferential direction thereof, that is, the direction denoted by arrow R in FIG. 3, by a drive device constituted by a motor M, a driving force transmission belt V, etc. A rotational passage region (a region that each portion of the sorbent rotor 50 passes through as the sorbent rotor rotates is divided into four regions which are hermetically isolated from each other by a casing (not shown) that rotatably houses the sorbent rotor 50. The four regions are a processing region 1a where the process air is dehumidified, a regenerating region 1b, a first purging region 1c, and a second purging region 1d. Each sorbent portion of the sorbent rotor 50 passes through the four regions in the order of 1a, 1b, 1c, 1d, 1a, . . . as the sorbent rotor 50 rotates.

The air processing channel 10 is in communication with the processing region 1a while maintaining a hermetically sealed state. The air processing channel 10 is a channel that supplies process air, that is, air which is a target of a dehumidifying process, to the sorbent rotor 50 and receives processed air SA which has passed through the sorbent rotor 50. In the present example, the process air and dehumidified by the sorbent rotor 50 is processed air which has been dehumidified by the sorbent rotor 20 for the first processing step. The air processing channel 10 is in communication with a space 19 at a side downstream from the sorbent rotor 50 via an aftercooler 16, an afterheater 17 (both omitted from FIG. 3) and a damper 18. Processed air SA is supplied to the space 19 in which dehumidified air is necessary, through the air processing channel 10. The space 19 is a space within a room in which lithium battery production, organic EL screen production, etc. is conducted.

In the present embodiment, a portion of utilized air, which is the processed air SA that has flowed through the space 19, is mixed with the external air OA, and is dehumidified again by the sorbent rotor 50 for the second processing step. As illustrated in FIG. 1, a utilized air channel 22 is provided with a damper 21, and the utilized air channel 22 is in communication with the air processing channel 10 at a side upstream from the sorbent rotor 50.

Meanwhile, as illustrated in FIG. 1 and FIG. 3, a circulating purging channel 40 that places the first purging region 1c and the second purging region 1d in communication with each other toward a first side surface of the sorbent rotor 50 and places the first purging region 1c and the second purging region 1d in communication with each other toward a second side surface of the sorbent rotor is provided. This circulating purging channel 40 is provided with a purging fan 41 that suctions air within the second purging region 1d and sends the air to the first purging region 1c, and returns the air which has passed through the first purging region 1c to the second purging region 1d. In addition, the circulating purging channel 40 is also provided with a damper 42 (omitted from FIG. 3).

A regenerating air channel 30 is in communication with the regenerating region 1b of the sorbent rotor 50 for the second processing step while maintaining a hermetically sealed state. The regenerating air channel 30 is a channel that air which enables the sorbent of the sorbent rotor 50 to be reutilized flows through. The regenerating air channel 30 is branched from the air processing channel 10 that air which has been dehumidified by the sorbent rotor 20 for the first processing step flows through. The regenerating air channel 30 is provided with a damper 31 and a regenerating heater 32 in this order from the point at which the regenerating air channel 30 branches from the air processing channel 10 toward the sorbent rotor 50 for the second processing step.

The regenerating air channel 30 also extends to the opposite side of the branching point with the air processing channel 10 while maintaining a hermetically sealed state, both upstream and downstream of the regenerating region 1b of the sorbent rotor 50 for the second processing step. The regenerating air channel 30 of this portion is in communication with the regenerating region 1b of the sorbent rotor 20 for the first processing step via a damper 33 and a regenerating heater 34, in this order while maintaining a hermetically sealed state. The regenerating air channel 30 extends further both upstream and downstream of the regenerating region 1b of the sorbent rotor 20 for the first processing step, and air is released to the atmosphere via a regenerating fan 35.

An atmospheric supply channel 36 is connected to the regenerating air channel 30 at a point between the damper 33 and the regenerating heater 34. The atmospheric supply channel 36 is a channel for mixing atmospheric air into regenerating air that flows through the regenerating air channel 30 through which regenerating air flows from the sorbent rotor 50 for the second processing step to the regenerating region 1b of the sorbent rotor 20 for the first processing step (this portion constitutes the second regenerating air channel of the present invention). A prefilter 37 that removes dust, etc. from air and a damper 38 are provided in this order from upstream at positions near the upstream end of the atmospheric supply channel 36. Note that the air processing channel 10 and the regenerating air channel 30 are provided such that they do not communicate with the circulating purging channel 40.

In the dehumidifying system 100 of the present embodiment, when dehumidified air is supplied to the space 19, the processing fans 5 and 15, the regenerating fan 35, and the purging fan 41 are driven, the regenerating heaters 32 and 34 are driven, and the sorbent rotor 20 for the first processing step and the sorbent rotor 50 for the second processing step are rotated with the dampers 3, 13, 18, 21, 31, 33, 38, and 42 in an open state. Thereby, process air (external air) OA as a target of dehumidification passes through the air processing channel 10, is sent to the processing region 1a of the sorbent rotor 20 for the first processing step, and passes through the sorbent at the processing region 1a of the sorbent rotor 20. At this time, the external air OA is cooled by the precooler 4.

When the process air passes thorough the sorbent of the sorbent rotor 20 for the first processing step, moisture contained in the air is adsorbed by the sorbent, and the air is dehumidified. The dehumidified processed air passes through the air processing channel 10 and is sent to the processing region 1a of the sorbent rotor 50 for the second processing step as process air OA after being cooled by the precooler 14. When the process air OA passes through the sorbent at the processing region 1a of the sorbent rotor 50, moisture contained in the air is adsorbed by the sorbent, further dehumidifying the air and decreasing the dew point thereof.

When process air is dehumidified in two steps in this manner, the regenerating heaters 32 and 34 are driven, and external air in a heated state passes through the sorbent at the regenerating region 1b of the sorbent rotor 50 for the second processing step and the sorbent at the regenerating region 1b of the sorbent rotor 20 for the first processing step. There, the moisture which is adsorbed by the sorbent of the sorbent rotors 50 and 20 is removed. Thereby, the sorbent of the sorbent rotors 50 and 20 is regenerated to a state in which reutilization for dehumidification is possible. The regenerating air which has passed through the sorbent of the sorbent rotor 20 is released to the atmosphere by the regenerating fan 35 as exhaust regenerating air EA that contains moisture removed from the sorbent.

In the present embodiment, the circulating purging channel 40 and the purging fan 41 are employed to perform precooling and preheating processes by circulated air on the sorbent rotor 50. That is, when the purging fan 41 causes air to circulate through the circulating purging channel 40, air that has passed through the second purging region 1d which is at a lower temperature than the high temperature regenerating region 1b is sent to the sorbent at the first purging region 1c of the sorbent rotor 50. There, the sorbent of the sorbent rotor 50 does not enter the processing region 1a at the high temperature to which it is heated in the regenerating region 1b, but the temperature thereof is decreased at the first purging region 1c, and then enters the processing region 1a (precooled). The process air passes through the processing region 1a which is at a comparatively low temperature, and is dehumidified efficiently. In addition, air which has been raised to a high temperature of 100 degrees Celsius or greater (a higher temperature than that of the processing region 1a) by passing through the first purging region 1c is sent to the second purging region 1d. The sorbent of the sorbent rotor 50 undergoes a preheating process at the second purging region 1d prior to entering the regenerating region 1b, and therefore a sorbent regenerating process is also conducted efficiently.

Conventionally, it had been considered difficult to apply a sorbent rotor provided with a circulating purging channel to precool and preheat sorbent as a sorbent rotor for a second processing step when process air in two steps by sorbent rotors for a first processing step and a second processing step. This is because in a conventional dehumidifying system equipped with a circulating purging channel, external air is taken in as regenerating air, limiting regenerating performance, thereby limiting a decrease in the dew point of the process air. In contrast, in the present embodiment, low humidity air which has passed through the sorbent rotor 20 for the first processing step is employed as regenerating air for the sorbent rotor 50 for the second processing step to solve this problem, thereby enabling application of the sorbent rotor 50 provided with the circulating purging channel 40 to precool and preheat sorbent. Note that in the second embodiment to be describe later, “air at a purge outlet of a sorbent rotor 25 for a first processing step” is employed as regenerating air for the sorbent rotor 50 for the second processing step instead of the “low humidity air which has passed through the sorbent rotor 20 for the first processing step”. Thereby, application of the sorbent rotor 50 provided with the circulating purging channel 40 to precool and preheat sorbent becomes similarly possible.

In the dehumidifying system 100 of the present embodiment, process air is dehumidified in two steps by the sorbent rotor 20 for the first processing step and the sorbent rotor 50 for the second processing step. Therefore, highly dehumidified air can be obtained. A sorbent rotor which is sectioned into four regions, which are the processing region 1a, the regenerating region 1b, the first purging region 1c, and the second purging region 1d, is applied as the sorbent rotor 50 for the second processing step. In addition, the circulating purging channel 40 that circulates air to pass alternately through the first purging region 1c and the second purging region 1d is provided. Therefore, the dehumidifying system 100 can reduce energy consumption by the sorbent rotor 50 for the second processing step, resulting in a reduction of energy consumption by the system as a whole.

The dehumidifying system 100 of the present embodiment is capable of further reducing energy consumption by the system as a whole by the points below. That is, the dehumidifying system 100 of the present embodiment is provided with the regenerating air channel 30 that sends at least a portion of the processed air which has been dehumidified by the sorbent rotor 20 for the first processing step to the regenerating region 1b of the sorbent rotor 50 for the second processing step. Thereby, it is possible to effectively utilize exhaust heat from the processed air to regenerate the sorbent rotor 50. Therefore, it is possible for the dehumidifying system 100 of the present embodiment to employ a low capacity, miniature heater as the regenerating heater 32 for the sorbent rotor 50 for the second processing step, thereby further reducing energy consumption by the system as a whole.

The dehumidifying system 100 of the present embodiment is also provided with the regenerating air channel 30 as the aforementioned second regenerating air channel of the present invention. Thereby, it is possible to effectively utilize exhaust heat from the processed air to regenerate the sorbent rotor 20 for the first processing step. Therefore, it is possible for the dehumidifying system 100 of the present embodiment to employ a low capacity, miniature heater as the regenerating heater 34 for the sorbent rotor 20 for the first processing step as well, thereby further reducing energy consumption by the system as a whole.

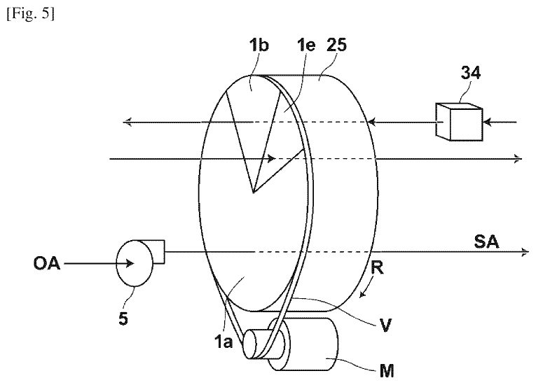

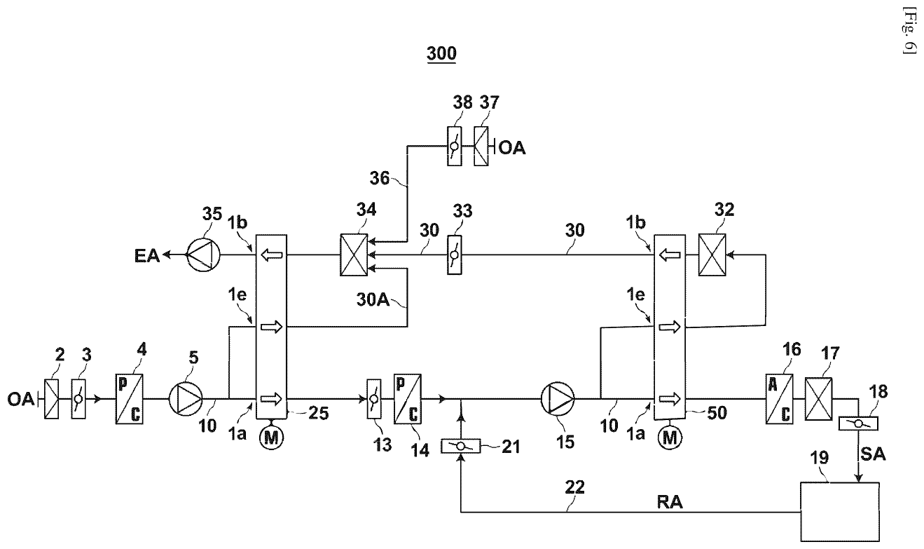

Next a dehumidifying system 200 according to a second embodiment of the present invention will be described with reference to FIG. 4 and FIG. 5. FIG. 4 illustrates the entire configuration of the dehumidifying system 200, and FIG. 5 illustrates the sorbent rotor 25 for the first processing step and peripheral components that constitute the dehumidifying system 200. If the dehumidifying system 200 of the present embodiment is compared with the dehumidifying system 100 of the first embodiment illustrated in FIG. 1 through FIG. 3, the configuration of the sorbent rotor 25 for the first processing step and the path of the regenerating air channel 30 differ, as illustrated in the figures. The remaining points are the same as the dehumidifying system 100 of the first embodiment, and therefore elements which are the same as those illustrated in FIG. 1 through FIG. 3 are denoted by the same reference numerals, and descriptions thereof will be omitted insofar as they are not particularly necessary.

A rotational passage region of the sorbent rotor 25 for the first processing step is sectioned into three hermetically isolated sections, which are a processing region 1a, a regenerating region 1b, and a purging region 1e. The purging region 1e is a region that precools the sorbent portion prior to transitioning to the processing region 1a in the same manner as the first purging region 1c of the first embodiment. Each sorbent portion within the sorbent rotor 25 passes through the three regions above in the order of 1a, 1b, 1e, 1a . . . as the sorbent rotor 25 rotates. Meanwhile, the regenerating air channel 30 is formed to guide air at a purge outlet which has passed through the purging region 1e to the regenerating region 1b of the sorbent rotor 50 for the second processing step.

In the dehumidifying system 200 of the present embodiment, the sorbent portions of the sorbent rotor 25 are precooled by the purging region 1e. Thereby, air at the purge outlet which has been heated to a certain degree is utilized to heat the regenerating region 1b of the sorbent rotor 50 for the second processing step and the regenerating region 1b of the sorbent rotor 25 for the first processing step. Accordingly, it is possible for energy consumption by the system as a whole to be reduced in the present embodiment, as in the first embodiment.

The energy consumption reducing effect of the dehumidifying systems 100 and 200 of the first and second embodiments will be concretely shown by a comparison with a conventional dehumidifying system. First, a conventional dehumidifying system 300, which is the target of the comparison, will be described with reference to FIG. 6. Note that in FIG. 6 as well, elements which are basically equivalent to those illustrated in FIGS. 1 and 4 are denoted with the same reference numerals, and descriptions thereof will be omitted insofar as they are not particularly necessary.

The dehumidifying system 300 illustrated in FIG. 6 also dehumidifies process air in two steps by employing a sorbent rotor 25 for a first processing step and a sorbent rotor 50 for a second processing step. The sorbent rotor 25 for the first processing step has a purging region 1e for precooling sorbent portions in the same manner as the sorbent rotor 25 for the first processing step in the dehumidifying system 200 of the second embodiment illustrated in FIG. 4. A portion of process air (external air OA) which is sent to the sorbent rotor 25 for the first processing step is sent to the purging region 1e. However, air at a purge outlet which has passed through the purging region 1e is not sent to a regenerating region 1b of the sorbent rotor 50 for the second processing step as regenerating air. Meanwhile, the sorbent rotor 50 for the second processing step is the same as the sorbent rotors 50 which are employed in the dehumidifying system 100 illustrated in FIG. 1 and the dehumidifying system 200 illustrated in FIG. 4. However, the circulating purging channel 40 is not provided in the sorbent rotor 50. Note that the air at the purge outlet which has passed through the purging region 1e flows through a regenerating air channel 30A, is heated by a regenerating heater 34, and then is sent to a regenerating region 1b of the sorbent rotor 25 for the first processing step. In addition, external air OA which is taken in from an atmospheric supply channel 36 and is heated by the regenerating heater 34 is also sent to the regenerating region 1b of the sorbent rotor 25.

The common and individual driving conditions of each of the dehumidifying systems in the comparison are as described below.
Dehumidifying Conditions for the Space 19: air is dehumidified to a standard dew point is to be decreased to less than or equal to −40 degrees Celsius at room temperature of 23 degrees Celsius, and an amount of dehumidification of greater than or equal to 600 g/h with respect to the ambient condition of a dew point of −40 degrees Celsius
Amount of Air Supplied to the Space 19: 11700 m³/h (=amount of exhaust air from the space 19 of 4000 m³/h+amount of returned utilized air RA of 7700 m³/h)
Dehumidifying System 300: an amount of introduced external air of 5800 m³/h and an amount of exhaust regenerating air EA of 1800 m³/h (amount of exhaust regenerating air EA=amount of external air OA/amount of utilized air RA introduced into the regenerating air channel 30)
Dehumidifying System 100: an amount of introduced external air of 5500 m³/h and an amount of exhaust regenerating air EA of 1500 m³/h
Dehumidifying System 200: an amount of introduced external air of 5500 m³/h and an amount of exhaust regenerating air EA of 1500 m³/h

Table 1 below shows driving electrical capacities (kW) of electrical means as amounts of energy which are consumed by each of the systems. Note that in Table 1, with respect to the precoolers 4 and 14 and the aftercooler 16 that do not utilize electricity but basically perform cooling using only water, amounts of utilized cooling water per minute (L: liters) are shown underneath electrical capacities in parentheses, which are converted from cooling performance corresponding to the amounts of utilized cooling water.

TABLE 1

| | System 300 | | System 100 | | System 200 | |
|---|---|---|---|---|---|---|
| Two Rotor Driving Motors M | 0.2 | kW | 0.2 | kW | 0.2 | kW |
| Processing Fan 5 | 5.5 | kW | 5.5 | kW | 5.5 | kW |
| Processing Fan 15 | 18.5 | kW | 11.0 | kW | 11.0 | kW |
| Regenerating Fan 35 | 2.2 | kW | 2.2 | kW | 2.2 | kW |
| Purging Fan 41 | None | | 0.4 | kW | 0.4 | kW |
| Regenerating Heater 34 | 27.0 | kW | 26.5 | kW | 26.0 | kW |
| Regenerating Heater 32 | 37.0 | kW | 24.9 | kW | 26.2 | kW |
| Precooler 4 | (136 | kW) | (115 | kW) | (121 | kW) |
| Amount of Cooling Water | 278 | L/min | 235 | L/min | 248 | L/min |
| Precooler 14 | (47 | kW) | (39 | kW) | (35 | kW) |
| Amount of Cooling Water | 97 | L/min | 80 | L/min | 71 | L/min |
| Aftercooler 16 | Not Driven | | (3 | kW) | Not Driven | |
| Amount of Cooling Water | | | 7.0 | L/min | | |
| Afterheater 17 | 10.0 | kW | Not Driven | | Not Driven | |
| Total Driving Electrical | 100.4 | kW | 70.7 | kW | 71.5 | kW |
| Capacity | | | | | | |
| Total Amount of Cooling Water | 375 | L/min | 322 | L/min | 319 | L/min |

According to Table 1, the total driving electrical capacity for the dehumidifying system 300, which is a conventional system, is 100.4 kW. In contrast, the total driving electrical capacity is 70.7 kW for the dehumidifying system 100 according to the present invention, and 71.5 kW for the dehumidifying system 200 according to the present invention. The driving electrical capacities of the dehumidifying system 100 and the dehumidifying system 200 are reduced in comparison to the conventional dehumidifying system 300. If the energy saving effect of the dehumidifying systems 100 and 200 with respect to the conventional system 300 are shown as percentages of reduced electrical capacity, the respective values are (100.4−70.7)/100.4=0.296 approximately 30% and (100.4−71.5)/100.4=0.288 approximately 29%, respectively.

Also according to Table 1, the total amount of utilized cooling water is 375 L/min for the dehumidifying system 300, which is a conventional system. In contrast, the total amount of utilized cooling water is 322 L/min for the dehumidifying system 100 of the present invention, and 319 L/min for the dehumidifying system 200 of the present invention. The amounts of utilized cooling water of the dehumidifying system 100 and the dehumidifying system 200 are reduced in comparison to the conventional dehumidifying system 300. If the energy saving effect of the dehumidifying systems 100 and 200 with respect to the conventional system 300 are shown as percentages of reduced amounts of cooling water, the respective values are (375−322)/375=0.14=14% and (375−319)/375=0.15=15%, respectively.

### REFERENCE SIGN LIST

1a processing region
1b regenerating region
1c first purging region
1d second purging region
1e purging region
2, 37 prefilter
3, 13, 18, 21, 31, 33, 38, 42 damper
4, 14 precooler
5, 15 processing fan
10 air processing channel
19 space
20, 25 sorbent rotor for a first processing step
22 utilized air channel
30, 30A regenerating air channel
32, 34 regenerating heater
35 regenerating fan
40 circulating purging channel
41 purging fan
50 sorbent rotor for a second processing step
100, 200, 300 dehumidifying system
EA exhaust regenerating air
OA external air
SA processed air

1.-4. (canceled)

5. A dehumidifying system that feeds process air to a sorbent rotor to cause moisture within the process air to be adsorbed onto a sorbent of the sorbent rotor to dehumidify the process air, and causes regenerating air to flow onto the sorbent of the sorbent rotor which has adsorbed moisture to regenerate the sorbent, the dehumidifying system comprising:
a sorbent rotor for a first processing step that dehumidifies the process air;
a sorbent rotor for a second processing step that receives processed air which has been dehumidified by the sorbent rotor for the first processing step and dehumidifies the processed air as the process air;
a circulating purging channel; and
a regenerating air channel, wherein
the sorbent rotor for the second processing step comprises a sorbent rotor having a rotational passage region that is sectioned into four regions including a processing region where the process air is dehumidified, a regenerating region where the sorbent is regenerated, a first purging region provided between the regenerating region and the processing region upstream from the regenerating region with respect to a rotational direction of the sorbent rotor, and a second purging region provided between the regenerating region and the processing region downstream from the regenerating region in the rotational direction of the sorbent rotor,
the circulating purging channel circulates air such that the air alternately passes through the first purging region and the second purging region, and
the regenerating air channel feeds at least a portion of the processed air which is processed by the sorbent rotor for the first processing step to the regenerating region of the sorbent rotor for the second processing step as regenerating air.

6. The dehumidifying system according to claim 5, further comprising a second regenerating air channel that feeds at least a portion of the processed air which has passed through the regenerating region of the sorbent rotor for the second processing step as regenerating air to the regenerating region of the sorbent rotor for the first processing step.

7. A dehumidifying system that feeds process air to a sorbent rotor to cause moisture within the process air to be adsorbed onto a sorbent of the sorbent rotor to dehumidify the process air, and causes regenerating air to flow onto the sorbent of the sorbent rotor which has adsorbed moisture to regenerate the sorbent, the dehumidifying system comprising:
a sorbent rotor for a first processing step that dehumidifies the process air;
a sorbent rotor for a second processing step that receives processed air which has been dehumidified by the sorbent rotor for the first processing step and dehumidifies the processed air as the process air;
a circulating purging channel; and
a regenerating air channel, wherein
the sorbent rotor for the second processing step comprises a sorbent rotor having a rotational passage region that is sectioned into four regions including a processing region where the process air is dehumidified, a regenerating region where the sorbent is regenerated, a first purging region provided between the regenerating region and the processing region upstream from the regenerating region with respect to a rotational direction of the sorbent rotor, and a second purging region provided between the regenerating region and the processing region downstream from the regenerating region with respect to the rotational direction of the sorbent rotor,
the circulating purging channel circulates air such that the air alternately passes through the first purging region and the second purging region,
the sorbent rotor for the first processing step comprises a sorbent rotor having a rotational passage region that is sectioned into a processing region where the process air is dehumidified, a regenerating region where the sorbent is regenerated, and a purging region provided between the regenerating region and the processing region where the sorbent is precooled prior to entering the processing region, and
the regenerating air channel feeds at least a portion of air at a purge outlet which has passed through the purging region of the sorbent rotor for the first processing step to the regenerating region of the sorbent rotor for the second processing step as regenerating air.

8. The dehumidifying system according to claim 7, further comprising a second regenerating air channel that feeds at least a portion of the air at the purge outlet which has passed through the regenerating region of the sorbent rotor for the second processing step as regenerating air to the regenerating region of the sorbent rotor for the first processing step.
